(19) United States
(12) Patent Application Publication
(10) Pub. No.: US 2009/0167258 A1
(43) Pub. Date: Jul. 2, 2009

(54) Magnetic torsion accelerator

(76) Inventor: Michael Peavey, Louisville, KY (US)

Correspondence Address: MICHAEL PEAVEY, P.O. BOX 6868, LOVISVILLE, KY, 40206, US

(21) Appl. No.: 12/005,202

(22) Filed: Dec. 26, 2007

(51) Int. Cl. H02K 21/20

(52) U.S. Cl. 322/48; 310/178; 310/181

(57) ABSTRACT

An inexpensive means of using homopolar technology to test some aspects of magnetic shear and reconnection on a variety of solid, liquid, gaseous, and plasma substances

### CROSS-REFERENCE TO RELATED APPLICATIONS

None

### FEDERALLY SPONSORED RESEARCH

None

### SEQUENCE LISTING

None

### FIELD OF THE INVENTION

This invention relates to homopolar machines and their use in the replication of naturally occurring magnetic shear and reconnection.

### BACKGROUND OF THE INVENTION

### Natural Magnetic Shear and Recombination

The high temperature of stars forms a neutral but ionized mass of electrons and positive ions called plasma. Magnetic shear and reconnection occurs on the surface of the sun whereby current sheets in plasma separate portions of the sun's magnetic field into isolated domains that become stretched, twisted, and eventually broken. This process of magnetic shear and reconnection accelerates charged particles, spewing fountains of luminous plasma into space.

The Earth's magnetic field is a shield against this “solar wind.” However, the captured particles put a drag on the field, stretching it out on one side. On Oct. 1, 2001 “For the first time, the link between two sites of magnetic reconnection has been observed in-situ, in 3-D”, said Philippe Escoubet, Cluster and Double Star project scientist of the European Space Agency (1).

### Nuclear Fusion

A tokamak is a torus-shaped device confining plasma in a twisted rope of magnetic fields. A circulating current and magneto hydrodynamic (MHD) forces partially confine the plasma. Some of the gas escapes due to “radially unstable motion.” The effect is proportional to the mass of the plasma (2).

### Homopolar Machines

Discovered by Michael Faraday in 1931, homopolar machines need no commutation, alternating magnetic poles or rectification. They have three major components: a rotor, field coils, and a flux path. The rotor is connected to the machine's shaft and turns at right angles to the magnetic flux of the field coils. A homopolar machine always cuts magnetic flux lines in the same direction.

The flux path of magnetically permeable material confines stray flux and directs the magnetic field lines into the rotor to improve interaction with the flux.

Homopolar Motors

In a homopolar motor a voltage is applied across the rotor at a right angle to the magnetic field. A force (J×B) produces torque at a right angle to both fields, proportional to the current and to the number of coil turns.

### Homopolar Generators

In the case of a homopolar generator, external torque turns the rotor within the magnetic field, inducing a voltage proportional to speed, number of coil turns, and magnitude of the magnetic field.

When current is drawn from the homopolar generator, it develops a J×B force called armature reaction or back torque (3).

In some machines the rotor comprises a dielectric (nonconducting) material. Turning a dielectric rotor between capacitor plates produces a flux path. Turning a dielectric rotor between the plates of an uncharged capacitor in a flux path charges the capacitor. (4)

### One-Piece Homopolar Generators

A rotary or stationary magnet produces the same effect on the rotor (5). In one-piece homopolar machines the magnetic field and rotor turn together. This configuration may resemble some of the internal electromagnetic workings of the Earth and the distortions of fluid flow occurring therein.

### SUMMARY OF THE INVENTION

A closed flux path incorporates a stationary and rotatable portion thereof.

A magnetically and electrically conductive rotor comprises an axle that comprises a rotatable portion of the flux path.

An axial current stabilizes magnetic domains within the flux path.

A means of torque turns the rotor, thereby applying torque to the rotating portion of the flux path, creating a torsion field.

An electric discharge cuts the flux path, thereby releasing energy stored in the torsion field. The flux path is thereby converted to a dipole field. The flux path contracts toward the center of the torsion field as the torsion field lines unwind. Angular momentum resists change in the direction of the rotor.

A test mass, secured in the axial flux path, absorbs said energy.

Well known devices may be used to observe and measure the effects that the released energy has on the substance of the test mass.

### BRIEF DESCRIPTION OF DRAWINGS

The various embodiments of the invention may be better understood by reference to the accompanying drawings wherein:

FIG. 1 is a section view through a homopolar machine, acting as a motor, featuring stationary magnetic windings, an electrically and magnetically conductive rotor with a rotatable portion of a flux path.

FIG. 2 is a section view through a homopolar machine, acting as a generator, featuring two counter-rotating rotors. The rotors are magnetically conductive and dielectric.

FIG. 3 is a section view through a homopolar machine, wherein the magnet turns with the rotor.

### DRAWING REFERENCE NUMERALS

100A and 100B stationary field coils
102 rotor, electrically and magnetically conductive
103 radial current flow
104 axis of rotor
106 electrically and magnetically conductive medium
107 axial flux path
108 discharge path
109 capacitor
110 test mass, rotating
111A and 111B input terminals
200A and 200B stationary field coils
201A and 201B input terminals
211A and 211B coaxial rotors
212 coaxial contra-rotating shafts
213 flux path
214A and 215A, 214B and 215B electric potentials
216 discharge path
217 capacitor
218 test mass, stationary
219 external source of torque
300A and 300B stationary field coils
301A and 301B input terminals
321 one-piece generator rotor
322 stationary magnetic field coil
353 discharge path, 354 capacitor
324 flux path
325 test mass, rotating

### REFERENCES CITED

1. “Satellite Observations of Separator Line Geometry of Three-Dimensional Magnetic Reconnection,” C. Xiao, X. Wang, Z. Pu, Z. Ma, H. Zhao, G. Zhou, J. Wang, M. Kivelson, S. Fu, Z. Liu, Q. Zong, M. Dunlop, K-H. Glassmeier, E. Lucek, H. Rème, I. Dandouras, C. Escoubet, Nature Physics, Jun. 24, 2007.
2. “Observation of Kinetic PlasmaJets in a Coronal-Loop Simulation Experiment,” Shreekrishna Tripathi, Paul Bellan, and Gunsu Yun, International Journal of Applied Electromagnetics and Mechanics, Volume 14, Numbers 1-4, 2001-2002, P. 115-120.
3. U.S. Pat. No. 406,968, “Dynamo Electric Machine,” Nikola Tesla, 1889.
4. The Homopolar Handbook by Thomas Valone (ISBN 0-9641070-1-5) 1994.
5. Das Gupta, Am J. Phys 31, 428, 1963.

### DETAILED DESCRIPTION OF FIRST EMBODIMENT

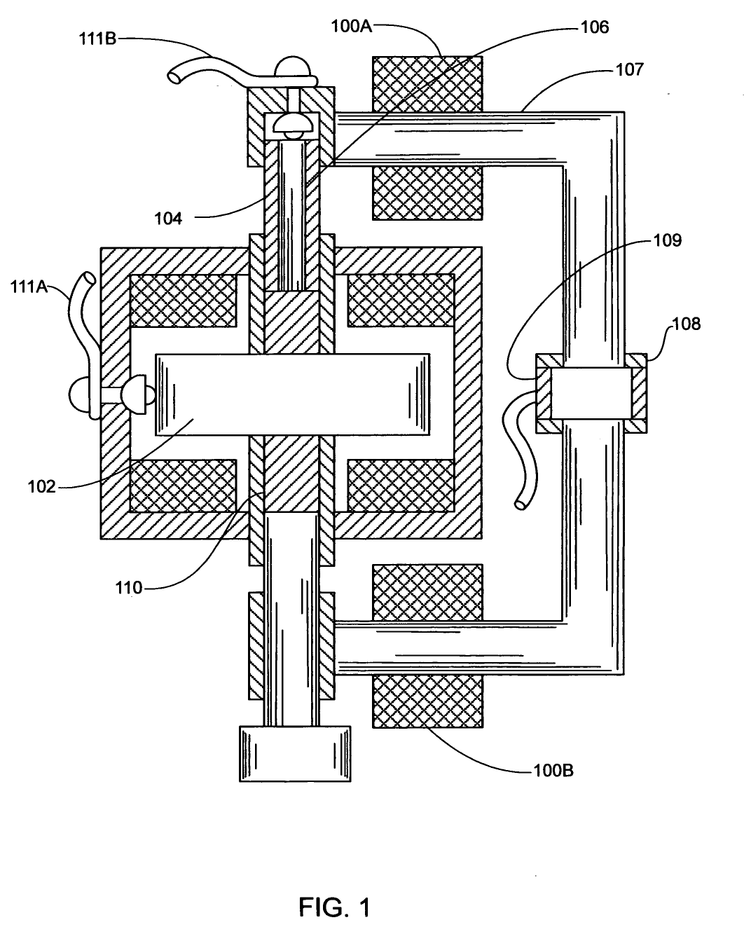

FIG. 1 is a section view that illustrates a first embodiment of the present invention featuring stationary magnetic field coils (100A and 100B), and a rotor (102) that is electrically and magnetically conductive.

Terminals (111A and 111B) direct current through the radius of the rotor (102). The interaction between the magnetic flux passing through the rotor (102) and the radial electric current, provide torque that turns the rotor (102) at a right angle to said current and magnetic flux path (107).

The return flux path passes through the rotor (102).

An axial current passes through an electrically and magnetically conductive medium (106) is parallel to the rotor axis and to the direction of the magnetic flux path in the axis. The current separates the flux path into separate magnetic domains which are fixed in place by the current.

The flux path and current turns the rotor (102) thereby applying torque to the domains in the flux path (106) creating a torsion field in the flux path (107). The distorted domains remain in magnetic shear because of the axial current.

A discharge path (108) allows a capacitor (109) to cut the field lines, thereby releasing the energy stored in the torsion field.

A stationary test mass (110) is secured centrally in the axial flux path to absorb said energy. Well known devices may be used to observe and measure the effects the released energy has on the substance of the test mass.

### Description of the Second Embodiment

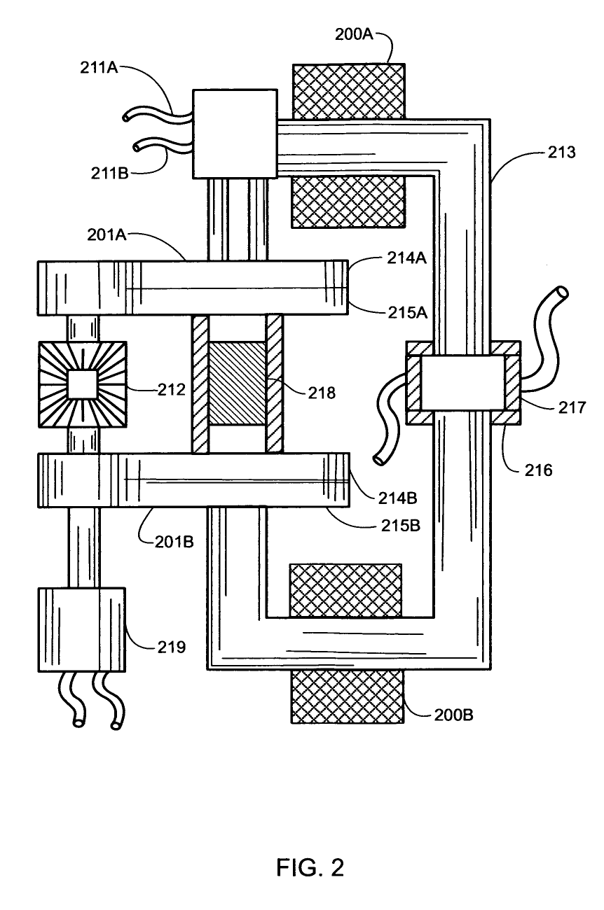

FIG. 2 is a section view that illustrates a second embodiment of the present invention featuring two coaxial rotors (201A and 201B) that are magnetically conductive but dielectric. Terminals (211A and 211B) supply current to the axial field and to the stationary field coils (200A and 200B).

An external source of torque (219) turns the rotors (201A and 201B) by coaxial contra-rotating shafts (212), This doubles their relative speed.

The flux path (213) extends through each rotor radially from the center to the rim in the upper half then back toward the axis in the lower half. The rotors (211A and 211B) form a widened portion of an otherwise constricted flux path (213). A static charge accumulates between the upper and lower half of each rotor (214A and 215A and 214B and 215B).

The opposing rotors (201A and 201B) provide torque on the axial flux path (213) creating a torsion field between them.

A discharge path (216) allows a capacitor, (217) to cut flux path (213) thereby releasing the energy stored within the torsion field.

A stationary test mass (218) is secured in the nonrotating flux path between the rotors to absorb said energy. Well known devices may be used to observe and measure the effects the released energy has on the the test mass.

### Description of the Third Embodiment

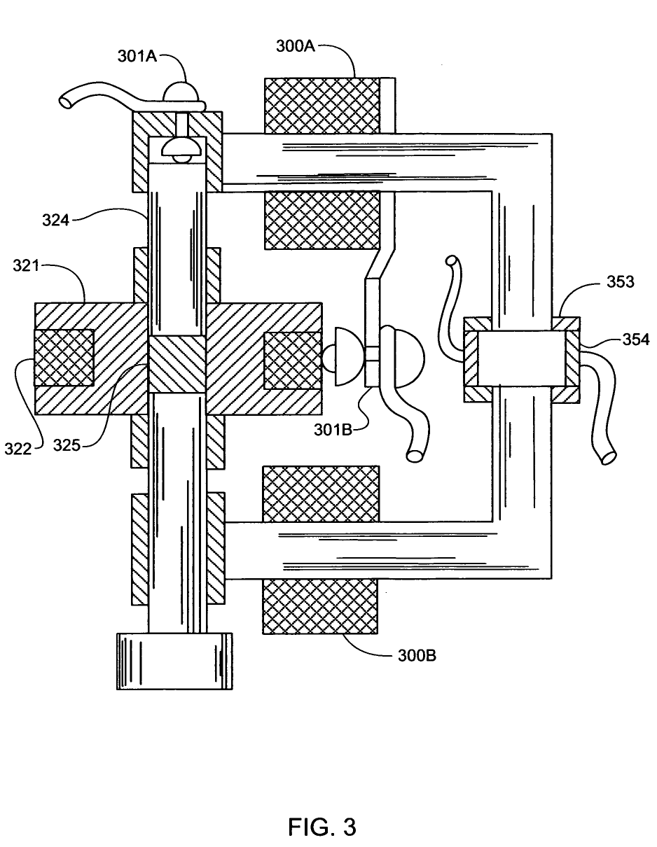

FIG. 3 is a section view that illustrates a third embodiment of the present invention. It features a rotor (321) with an an integral magnetic field coil (322) turning together. The material of the rotor (321) is both electrically and magnetically conductive. Stationary field coils (300A and 300B) generate the flux path. Terminals (301A and 301B) supply axial current, the field coils, and the rotor. The rotor torque applies energy to the magnetic domains isolated by the axial current thereby creating a torsion field.

A discharge path (353) allows a capacitor (354), to cut the flux path (324) thereby releasing the energy stored in the torsion field.

A test mass (325) is secured in the axial flux path to absorb the energy. Well known devices may be used to observe and measure the effects the released energy has on the substance of the test mass.

### Conclusion, Ramifications and Scope

Other modifications and variations of the present invention may be possible with the technology revealed herein. Features of the invention are emphasized in the Claims. The embodiments described herein are merely illustrative and should not be considered restrictive in any way. The scope of the invention is given by the appended claims, rather than in the description, and all variations and equivalents which fall within the range of the claims are intended to be embraced therein. However, it will be readily apparent to those skilled in the art that it is possible to embody the invention in specific forms other than those of the embodiments described above. This can be done without departing from the spirit of the invention. It is to be understood that within the scope of the Claims, the invention may be practiced otherwise than as specifically described.

Changes and modifications obvious to one skilled in this art may be made without departing from the scope of the invention as set forth in the claims.

### Combinations of Embodiments

Some features of the embodiments are interchangeable and may be combined in hybrid versions within the purpose of the embodiments and Claims.

### Magnetic Fields and Terminals

Electromagnets and/or permanent magnets may be used. Any means including sliding and roller contacts, conductive belt drives, and induction may be used within the purpose of the embodiments and Claims

### Rotors

Rotors may be radially or spirally segmented to prevent eddy currents.

Said conductive rotor may be comprised of, any solid, liquid, gas, or plasma and may rotate within the walls of a stationary or rotating chamber. The dielectric rotors may be comprised of, but not limited to, ceramic magnets.

Any number of co-rotating or counter-rotating rotors may be used in combination with any of the embodiments mentioned herein.

### Domain Separation

Among the choices for the electrically and magnetically conductive medium through which the axial current flows include any solid, liquid, gaseous, or vacuum media which is magnetic and electrically conductive.

In some embodiments, the flux path through the axis may be divided by an electrically conductive non magnetic material.

### Discharge Path

The before-mentioned discharge path may comprise any part of the flux path. The means of electric discharge may be a capacitor or any other electric discharge device, positioned to discharge at any angle through the flux path.

### Test Mass

Said test mass may be comprised of, hydrogen hydrides, any other metal, solid, liquid, gas, or plasma, Said test mass may be a functional part of the machine, such as the rotor axle, and may be stationary, or rotate.

The invention claimed is:

1. A homopolar generator with a means of converting magnetic shear into energy, said means comprising the following steps:
a. a magnet produces generally parallel field lines in a predetermined direction within a continuous flux path, said flux path having stationary and rotating portions thereof;
b. an axial current runs through said flux path, parallel to said field lines of said flux path, thereby separating said field lines into magnetic domains;
c. said stationary portion of said flux path intersects a rotor so that said rotor turns in a predetermined direction, the axis of the turning rotor comprising said rotating portion of said flux path;
d. said turning rotor causes torsion and shear in said magnetic domains of said rotating portion of said flux path, thereby storing energy therein;
e. at a predetermined time, a means of electric discharge cuts said field lines thereby releasing said stored energy;
f. a test mass, at a predetermined point in the flux path, converts said released energy to an output of energy capable of being measured.

2. A homopolar generator with a means of converting magnetic shear into energy said means comprising the following steps:
a. a magnet produces generally parallel field lines in a predetermined direction within a continuous flux path, having stationary and rotating portions thereof;
b. an axial current runs through said flux path, parallel to said field lines of said flux path, thereby separating said field lines into magnetic domains;
c. said stationary portion of said flux path intersects a magnetically conductive dielectric rotor, the axis of said rotor comprising the rotatable portion of said flux path;
d. an external source of torque turns said rotor in a predetermined direction, said turning rotor causes shear in said magnetic domains of said rotating portion of said flux path, thereby storing energy therein;
e. at a predetermined time, a means of electric discharge cuts said field lines thereby releasing said stored energy;
f. a test mass, at a predetermined point in the flux path, converts said released energy to an output of energy capable of being measured.

3. The method of claim 1 wherein said homopolar machine employs a permanent magnet as the source of said flux path.

4. The method of claim 1 wherein said homopolar machine employs a combination of permanent magnet and electromagnets.

5. The method of claim 1 whereby said rotor employs any combination of substances of solid, liquid, gas, or plasma.

7. The method of claim 1 whereby said test mass is part of a larger object.

6. The method of claim 2, wherein the flux path induces a static electric charge in the rotor, the rotor being comprised of dielectric material.

7. The method of claim 2 whereby said test mass is part of a larger object.
